(19) United States
(12) Patent Application Publication
(10) Pub. No.: US 2026/0024303 A1
(43) Pub. Date: Jan. 22, 2026

(54) IMAGE PROCESSING APPARATUS FOR POSE ESTIMATION WITH REDUCED ERRORS, CONTROL METHOD THEREFOR, AND COMPUTER PROGRAM PRODUCT

(71) Applicant: CANON KABUSHIKI KAISHA, Tokyo (JP)

(72) Inventor: KYOSUKE TAKAHASHI, Kanagawa (JP)

(21) Appl. No.: 19/220,618

(22) Filed: May 28, 2025

(30) Foreign Application Priority Data
Jul. 16, 2024 (JP) 2024-113309

(51) Int. Cl. G06V 10/46; G06T 7/70

(52) U.S. Cl. CPC G06V 10/46; G06T 7/70

(57) ABSTRACT

An image processing apparatus is configured to reduce erroneous results in pose estimation for a subject. The image processing apparatus detects a plurality of keypoints for a subject in an image and determines whether the keypoints belong to the same subject. The image processing apparatus extracts a bounding box that encloses a body part of a subject in the image and indicates a detection range of the subject, and determines whether the bounding box corresponds to the same subject as the keypoints. According to at least a positional relationship between the keypoints determined to belong to the same subject and the bounding box determined to correspond to the same subject as the keypoints, the confidence level of at least one of the bounding box and the keypoints is reduced, or the confidence level of pose estimation for the subject using the keypoints is reduced.

### BACKGROUND

### Field of the Technology

The present disclosure relates to image processing apparatuses, methods for controlling the image processing apparatuses, and computer program products.

### Description of the Related Art

In the field of computer vision, object detection is a technology that identifies objects in an image and displays bounding boxes around the identified objects as detection results. The object detection technology is applied, for example, to pose estimation, in which keypoints (feature points) such as a person's joints are detected in an image, and the person's pose is estimated based on the detected keypoints. Pose estimation techniques are generally categorized into top-down and bottom-up approaches. In the top-down approach, a person is first detected in an image, and their pose is then estimated based on the detection of keypoints that are predefined for that person. In contrast, in the bottom-up approach, multiple keypoints are detected in the image and then connected, i.e., linked together, with straight lines to estimate the pose of the person. Although the top-down approach typically provides higher accuracy in pose estimation compared to the bottom-up approach, it tends to incur a higher computational cost. The bottom-up approach, on the other hand, requires less computation during pose estimation than the top-down approach; however, it is more prone to errors such as misdetection of keypoints and incorrect connections between keypoints. Moreover, in the bottom-up approach, such misdetections or incorrect connections of keypoints may lead to an estimated pose of the person that is not unnatural, i.e., within the plausible range of human poses. In such cases, the estimated pose of the person produces an erroneous result. As an example of a conventional bottom-up pose estimation technique, reference may be made to the following prior art: Alejandro Newell, Zhiao Huang, and Jia Deng, “Associative Embedding: End-to-End Learning for Joint Detection and Grouping,” Advances in Neural Information Processing Systems, vol. 30, pp. 2278-2288, 2017. In addition, Japanese Patent Application Laid-Open No. 2023-68992 discloses a device that performs a detection process to detect multiple types of body parts of a subject in an image. The device selects one of a plurality of determination methods for determining the subject's behavior based on the result of the detection process. Each of the determination methods employs a positional relationship between two or more types of body parts, among the multiple types of body parts, to determine the subject's behavior. The subject's behavior is then determined according to the selected determination method.

However, in the conventional bottom-up pose estimation technique described in the aforementioned prior art, when keypoints are misdetected or incorrectly connected, an estimated pose of a person may produce an erroneous result, as discussed above.

### SUMMARY

Embodiments described herein are directed to technologies that reduce erroneous results in pose estimation for a subject.

In one embodiment, an image processing apparatus includes one or more processors, and at least one memory coupled to the one or more processors and having stored thereon instructions which, when executed by the one or more processors, cause the one or more processors to detect a plurality of keypoints for a subject in an image and to determine whether the keypoints belong to the same subject. The one or more processors are also caused to extract a bounding box that encloses a body part of a subject in the image and indicates a detection range of the subject, and to determine whether the bounding box corresponds to the same subject as the keypoints. According to at least a positional relationship between the keypoints determined to belong to the same subject and the bounding box determined to correspond to the same subject as the keypoints, the one or more processors are further caused to reduce the confidence level of at least one of the bounding box and the keypoints, or reduce the confidence level of pose estimation for the subject using the keypoints.

In another embodiment, an image processing apparatus includes one or more processors, and at least one memory coupled to the one or more processors and having stored thereon instructions which, when executed by the one or more processors, cause the one or more processors to detect a plurality of keypoints for a subject in an image and to connect the keypoints with a straight line. The one or more processors are also caused to extract a bounding box that encloses a body part of a subject in the image, the subject being a target for pose or action estimation, and that indicates a detection range of the subject, and to determine whether the bounding box corresponds to the same subject as the keypoints. When the bounding box is determined to correspond to the same subject as the keypoints, the one or more processors are further caused to determine keypoints to be connected, among the detected keypoints, according to at least a positional relationship between the detected keypoints and the extracted bounding box.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a hardware configuration of an imaging device according to a first embodiment.

FIG. 2 is a flowchart illustrating a pose estimation process using a bottom-up approach.

FIG. 3 is a flowchart illustrating a pose estimation process using a top-down approach.

FIG. 4 is a flowchart illustrating a pose estimation process performed by the imaging device according to the first embodiment.

FIG. 5 is a diagram illustrating an example of an input image, sent from an imaging controller to an object detector, on which keypoints and a bounding box are superimposed.

FIG. 6 is a diagram illustrating another example of an input image, sent from the imaging controller to the object detector, on which keypoints and a bounding box are superimposed.

FIG. 7 is a flowchart illustrating a pose estimation process performed by an imaging device according to a second embodiment.

FIG. 8 is a diagram illustrating an example of an input image, sent from an imaging controller to an object detector of an imaging device according to a third embodiment, on which keypoints and bounding boxes are superimposed.

FIG. 9 is a diagram illustrating another example of an input image, sent from the imaging controller to the object detector of the imaging device according to the third embodiment, on which keypoints and bounding boxes are superimposed.

FIG. 10 is a flowchart illustrating a pose estimation process performed by an imaging device according to a fifth embodiment.

FIG. 11 is a diagram illustrating an example of an input image, sent from an imaging controller to an object detector of the imaging device according to the fifth embodiment, on which keypoints and bounding boxes are superimposed.

FIG. 12 is a diagram illustrating another example of an input image, sent from the imaging controller to the object detector of the imaging device according to the fifth embodiment, on which keypoints and bounding boxes are superimposed.

FIG. 13 is a diagram illustrating another example of an input image, sent from the imaging controller to the object detector of the imaging device according to the fifth embodiment, on which keypoints and bounding boxes are superimposed.

FIG. 14 is a diagram illustrating another example of an input image, sent from the imaging controller to the object detector of the imaging device according to the fifth embodiment, on which keypoints and bounding boxes are superimposed.

### DESCRIPTION OF THE EMBODIMENTS

Exemplary embodiments will be described in detail below with reference to the accompanying drawings. It should be noted that the following embodiments are provided for illustrative purposes only and are not intended to limit the scope of the disclosure. While multiple features may be described in each embodiment, the disclosure is not limited to embodiments that incorporate all such features, and various combinations of these features may be contemplated as appropriate. Additionally, in the drawings, like reference numerals designate like or corresponding components, and duplicative descriptions thereof will be omitted to avoid redundancy.

### First Embodiment

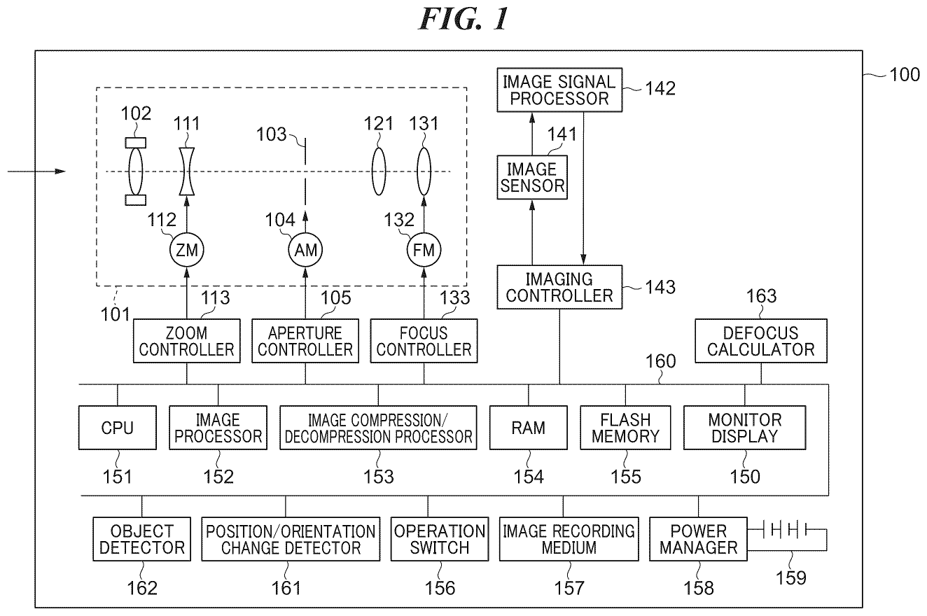

A first embodiment will be described below with reference to FIGS. 1 to 6. FIG. 1 is a block diagram illustrating an example of a hardware configuration of an imaging device according to a first embodiment. In this embodiment, an imaging device 100 illustrated in FIG. 1 may be, but is not limited to, a digital still camera or a video camera that incorporates an image processing apparatus. The imaging device 100 includes a lens assembly 101, an aperture controller 105, a zoom controller 113, a focus controller 133, an image sensor 141, an image signal processor 142, and an imaging controller 143. The imaging device 100 also includes a monitor display 150, a central processing unit (CPU) 151, an image processor 152, an image compression/decompression processor 153, a random-access memory (RAM) 154, and a flash memory 155. The imaging device 100 further includes an operation switch 156, an image recording medium 157, a power manager 158, a battery 159, a position/orientation change detector 161, an object detector 162, and a defocus calculator 163. These hardware components of the imaging device 100 are communicably connected to one another via a bus 160. The lens assembly 101 includes a fixed first lens group 102, an aperture 103, an aperture motor (AM) 104, a zoom lens 111, a zoom motor (ZM) 112, a fixed third lens group 121, a focus lens 131, and a focus motor (FM) 132.

The CPU 151 is a computer that controls the operation of each hardware component. The aperture controller 105 drives the aperture 103 through the aperture motor 104. This allows the aperture diameter of the aperture 103 to be adjusted, thereby enabling control of the amount of light during imaging. The zoom controller 113 drives the zoom lens 111 through the zoom motor 112, allowing the focal length to be changed. The focus controller 133 determines the drive amount to drive the focus motor 132 based on the amount of deviation in the focus direction (defocus amount) of the lens assembly 101. The focus controller 133 also drives the focus lens 131 through the focus motor 132, thereby enabling control of the focus adjustment state. The movement of the focus lens 131 enables autofocus (AF) control. Note that the focus lens 131 is a lens for focus adjustment, and while it is illustrated as a single lens in FIG. 1, it typically includes a plurality of lenses. An image of a subject is formed on the image sensor 141 through the lens assembly 101, and the subject image is converted into an electrical signal by the image sensor 141. The image sensor 141 is a photoelectric conversion element. The image sensor 141 is provided with photodetectors arranged as m pixels (where “m” is an integer) in the horizontal direction and n pixels (where “n” is an integer) in the vertical direction. The image formed on the image sensor 141 and photoelectrically converted is processed by the image signal processor 142 into an image signal (image data). In this manner, an image is captured on the imaging surface of the image sensor 141. As described above, in this embodiment, the image sensor 141 and other components constitute an imager configured to capture a subject and acquire an image thereof.

The image signal processor 142 outputs the image data. The image data is sent to the imaging controller 143 and temporarily stored in the RAM 154. The image data stored in the RAM 154 is compressed by the image compression/decompression processor 153 and then recorded on the image recording medium 157. In parallel with this recording, the image data stored in the RAM 154 is also sent to the image processor 152. The image processor 152 processes the image signal by performing operations such as resizing (enlarging or reducing) the image data and calculating the similarity between image data sets. The image data, having been resized to an optimal size by the image processor 152, is then displayed as an image on the monitor display 150. The monitor display 150 can also display a preview image or a through image and is capable of superimposing object detection results from the object detector 162 onto the image data. In the imaging device 100, the RAM 154 can be used as a ring buffer. This allows buffering of, for example, a plurality of image data sets captured within a predetermined period, detection results from the object detector 162 corresponding to each image data set, and changes in the position and orientation of the imaging device 100 acquired by the position/orientation change detector 161.

The operation switch 156 is an input interface including, for example, a touch panel or buttons. This enables the user to perform operations such as selecting various function icons displayed on the monitor display 150. The CPU 151 can determine the accumulation time of the image sensor 141 based on a user instruction entered via the operation switch 156 or the magnitude of pixel signals in the image data temporarily stored in the RAM 154. The CPU 151 can also determine a gain setting value to be applied when signals are output from the image sensor 141 to the image signal processor 142. The imaging controller 143 receives instructions regarding the accumulation time and the gain setting value from the CPU 151 and controls the image sensor 141 accordingly. The object detector 162 uses the image signal to determine a region in the image where a predetermined subject is present. This region may be output as a rectangular representation or, alternatively, as a subject region map in which the pixel values indicate the likelihood that the subject is present. The focus controller 133 can perform AF control for a specific subject region. The aperture controller 105 can perform exposure control using the luminance value of the specific subject region. The image processor 152 can perform gamma correction, white balance adjustment, and the like based on the subject region.

The battery 159 is managed by the power manager 158 and supplies power to the hardware components of the imaging device 100. The flash memory 155 stores control programs necessary for the operation of the imaging device 100 and parameters used for the operation of each component. The control programs include, for example, programs that cause a computer to implement the hardware components of the imaging device 100, namely, the individual functions and operations thereof (or a method for controlling the image processing apparatus). When the imaging device 100 is started by a user operation, i.e., when it transitions from a power-off state to a power-on state, the control programs and parameters stored in the flash memory 155 are loaded into a portion of the RAM 154. The CPU 151 controls the operation of the hardware components according to the control programs and parameters loaded into the RAM 154. The position/orientation change detector 161 includes sensors that detect position and orientation, such as a gyroscope, an accelerometer, and an electronic compass. The position/orientation change detector 161 measures changes in the position and orientation of the imaging device 100 with respect to the shooting scene. Information on the position and orientation changes measured by the position/orientation change detector 161 is stored in the RAM 154. The defocus calculator 163 calculates the amount of defocus for an arbitrary region in the image. The defocus amount may be output as a single value at a point or, alternatively, as a defocus map in which values are calculated at regular intervals across the entire image and arranged in a map format. The defocus amount is stored in the RAM 154 and can be referenced by the image processor 152.

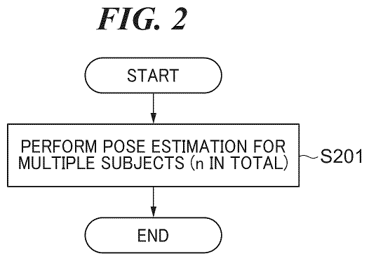

In this embodiment, the image captured by the imager is input to the object detector 162 from the imaging controller 143. Under the control of the CPU 151, the object detector 162 detects a subject in the input image and estimates the pose of the subject. This embodiment employs a bottom-up approach for pose estimation. In the bottom-up approach, when the input image contains a plurality of subjects (persons), pose estimation is performed simultaneously for all of the subjects. FIG. 2 is a flowchart illustrating a pose estimation process using the bottom-up approach. With reference to FIG. 2, in step S201, the object detector 162 performs pose estimation simultaneously for all subjects present in the input image. In this embodiment, a neural network is used for pose estimation. The neural network simultaneously outputs the positions of keypoints for the subjects and tags used to determine which keypoints belong to the same person.

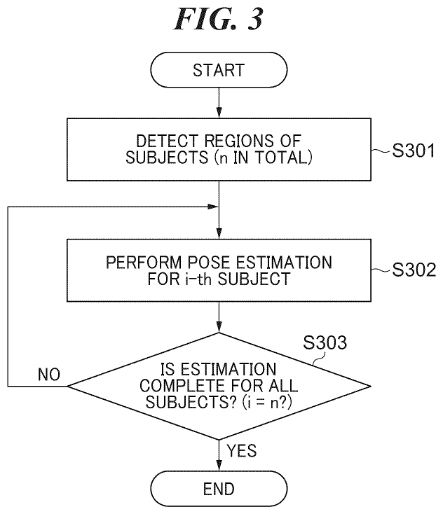

As another approach to pose estimation, a top-down approach may also be used. In the top-down approach, when the input image contains a plurality of subjects (persons), regions corresponding to the individual subjects are first detected, followed by the estimation of their respective poses. FIG. 3 is a flowchart illustrating a pose estimation process using the top-down approach. With reference to FIG. 3, in step S301, the object detector 162 detects the regions of subjects present in the input image. In step S302, the object detector 162 estimates the pose of each subject in the regions detected in step S301. In step S303, the object detector 162 determines whether the pose estimation in step S302 has been completed for the number of subjects detected in step S301. If it is determined that the estimation has been completed (Yes in step S303), the process ends. On the other hand, if it is determined that the estimation has not yet been completed (No in step S303), the process returns to step S302, and the subsequent steps are performed in sequence.

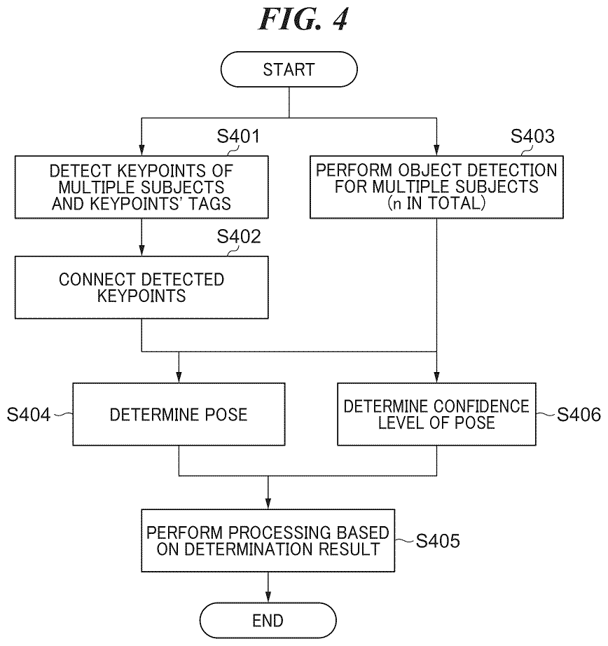

FIG. 4 is a flowchart illustrating a pose estimation process performed by the imaging device according to the first embodiment. Steps S401 and S402 in FIG. 4 correspond to the detailed process of step S201 in the flowchart illustrated in FIG. 2. As illustrated in FIG. 4, in step S401, the object detector 162 detects keypoints and their respective tags for a plurality of subjects present in the input image from the imaging controller 143, using, for example, a neural network. In this embodiment, the subject is assumed to be a person (human); however, it is not limited thereto. For example, the subject may also be a non-human animal or the like. When the subject is a person, for example, at least one of the following body parts is detected (extracted) as a keypoint: pupils, ears, top of the head (crown), neck, shoulders, elbows, wrists, hips, knees, and ankles. These keypoints serve as feature points that may contribute to estimating the pose of the person. Each keypoint includes position information indicating the corresponding body part and a likelihood representing the accuracy of the position information. The tags are used to determine whether individual keypoints belong to the same person. Each tag includes classification information (person identification information) indicating to which person the corresponding keypoint belongs and a likelihood representing the accuracy of the classification information. In this manner, the object detector 162 of this embodiment also has a function of detecting keypoints and tags.

In step S402, the object detector 162 connects the keypoints detected in step S401 with straight lines. In this manner, the object detector 162 of this embodiment also has a function of connecting keypoints with straight lines. The object detector 162 then estimates the pose of each person based on the result of connecting the keypoints with straight lines. In this manner, the object detector 162 of this embodiment also has a function of estimating the pose of a target person for pose estimation. In the process of step S402, the connections are typically determined based on the relative positions of the keypoints and the likelihoods of their tags. In this embodiment, tag information is used to determine the connections; however, the connections may alternatively be determined through segmentation of the subject. Note that if the likelihood of the classification information included in the tags is equal to or greater than a predetermined threshold and the maximum value is used, the connections between the keypoints may already be definitively determined during keypoint detection in step S401. In such cases, step S402 can be effectively omitted, and steps S401 and S402 in FIG. 4 may be represented as a single step, as in step S201 in FIG. 2.

Step S403 is performed in parallel with steps S401 and S402. In step S403, the object detector 162 extracts a bounding box (detection frame) for each person present in the input image from the imaging controller 143, using, for example, a neural network. The bounding box encloses, with a rectangle, a body part of a target person for pose estimation in the input image and indicates a detection range of the person. Preferably, the range enclosed by the bounding box is sufficient to enable reliable identification of the body part. For example, the bounding box preferably encloses the entire body, the entire upper body, or the entire head of the target person for pose estimation. Additionally, in step S403, the center of the bounding box, as well as its vertical and horizontal dimensions (i.e., height and width), is also extracted in association with the extraction of the bounding box. In this manner, the object detector 162 of this embodiment also has a function of extracting bounding boxes. Furthermore, in cases where, for example, bounding boxes are extracted for the face, head, upper body, and entire body, it is determined whether these bounding boxes correspond to the same person based on the degree of overlap between the bounding boxes or the distances between them.

In step S404, the object detector 162 determines, for example, that the person is in a running pose based on the result of the pose estimation performed for the person in step S402. In this embodiment, the confidence level of the pose is determined based on the positional relationship between the keypoints connected in step S402 (i.e., the keypoint group) and the bounding box extracted in step S403.

In step S405, the object detector 162 issues, via the CPU 151, an instruction to perform processing, such as switching the focus range of the imaging device 100, according to the determination result obtained in step S404.

In step S406, the object detector 162 determines whether the bounding box extracted in step S403 corresponds to the same person as the keypoints detected in step S401. This determination may be made based on the degree of overlap between a region formed by the multiple keypoints and the bounding box, or on the distance between the keypoints and the bounding box. Specifically, for example, a minimum circle or rectangle encompassing the keypoints corresponding to the top of the head and the neck may be formed and compared with the bounding box for the head. Alternatively, a rectangle formed by connecting the keypoints corresponding to the left and right shoulders and hips may be compared with the bounding box for the upper body. A simple distance-based comparison between the keypoints and the bounding box may also be employed. If the keypoints and the bounding box are determined to correspond to the same person, a check is performed, as described below, to determine whether there is any inconsistency between the keypoints and the bounding box determined to correspond to the same person.

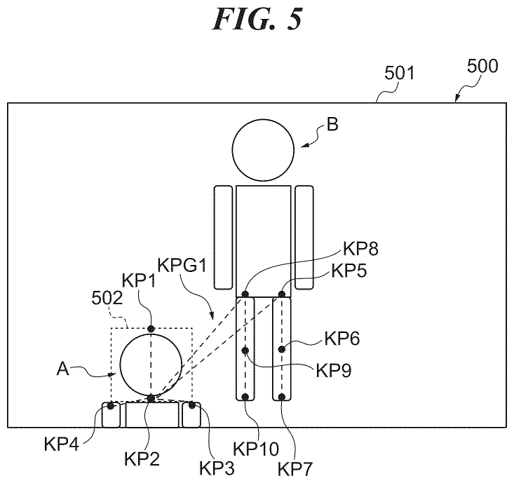

FIG. 5 is a diagram illustrating an example of an input image, sent from the imaging controller to the object detector, on which keypoints and a bounding box are superimposed. In an image 500 illustrated in FIG. 5, a solid line 501 represents the outer boundary of the image 500. The image 500 contains Person A and Person B. Person A is located in the lower-left area of the image 500, with the upper body from the chest upward captured. Person B is located in the central area of the image 500, with the entire body captured. A bounding box 502 represents the detection result for the head of Person A and is indicated by a dotted line surrounding the head of Person A. FIG. 5 also illustrates an example of detected keypoints. The detected keypoints include KP1 corresponding to the top of the head, KP2 corresponding to the neck, KP3 corresponding to the left shoulder, and KP4 corresponding to the right shoulder. The detected keypoints also include KP5 corresponding to the left hip, KP6 corresponding to the left knee, and KP7 corresponding to the left ankle. The detected keypoints further include KP8 corresponding to the right hip, KP9 corresponding to the right knee, and KP10 corresponding to the right ankle. Among the keypoints KP1 to KP10, KP1 to KP4 belong to Person A. Although the keypoints KP5 to KP10 actually belong to Person B, they have been detected as keypoints for the hips, knees, and ankles of Person A, which are out of the frame. In this manner, the object detector 162 determines that a plurality of keypoints belong to the same subject.

The term “same subject (person)” as used herein refers to one and the same individual. The keypoints KP1 to KP10 are connected by dashed lines to form a keypoint group KPG1. As a result, the object detector 162 erroneously determines, based on the keypoint group KPG1, that Person A is in a pose suggesting that they are lying down. Note that the keypoints are not limited to KP1 to KP10, and other keypoints may also be detected.

For example, suppose that the keypoint KP1 corresponding to the top of the head is located within a range of ±30 degrees relative to the keypoint KP2 corresponding to the neck, centered on a vertical axis in the image 500, and that the center of the head bounding box 502 is located within a distance equal to twice the size of the bounding box 502 from the lower edge of the image 500. In this case, it is highly likely that Person A is not bending their body or neck, that the upper body is partially out of the frame, and that the keypoints corresponding to the hips, knees, and ankles are missing from the image. When, as in this case, there is an inconsistency between the bounding box 502 and the positions of the detected keypoints (KP5 to KP10), the object detector 162 determines the pose with a reduced confidence level. In reducing the confidence level for the pose, any of the following three processes may be selectively performed.

The first process involves reducing the confidence levels of the keypoints KP5 to KP10. Specifically, for example, some of the keypoints included in the keypoint group KPG1, namely the keypoints KP5 to KP10 corresponding to the hips, knees, and ankles, may either be excluded from use or have their detected likelihoods reduced for use in the subsequent step.

The second process involves reducing the confidence level of the bounding box 502. Specifically, for example, the bounding box 502 may be excluded from use in subsequent steps.

The third process involves reducing the confidence level of the pose estimation based on the keypoint group KPG1. Specifically, for example, although the pose is initially estimated to be a lying-down pose based on the keypoint group KPG1, the positional relationship between the bounding box 502 and the keypoint KP1 corresponding to the top of the head suggests a standing pose. Therefore, the pose is not considered a lying-down pose in the estimation result. By incorporating such a process of reducing the confidence level (hereinafter referred to as the “confidence reduction process”), it is possible to reduce the likelihood of an erroneous determination in step S404, where Person A is determined to be in a pose suggesting that they are lying down. This process also helps prevent erroneous processing in step S405, which is based on the determination result obtained in step S404.

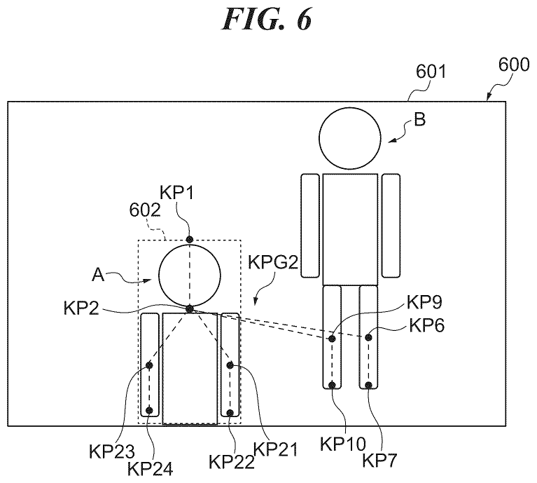

FIG. 6 is a diagram illustrating another example of an input image, sent from the imaging controller to the object detector, on which keypoints and a bounding box are superimposed. In the example of FIG. 6, the keypoints corresponding to the shoulders and hips are reduced to account for the reduction in computational load. In an image 600 illustrated in FIG. 6, a solid line 601 represents the outer boundary of the image 600. The image 600 contains Person A and Person B. Person A is located in the lower-left area of the image 600, with the upper body from the hips upward captured. Person B is located slightly to the right of the center of the image 600, with the entire body captured. A bounding box 602 represents the detection result for the entire upper body of Person A and is indicated by a dotted line surrounding the entire upper body of Person A. FIG. 6 also illustrates an example of detected keypoints. The detected keypoints include KP1 corresponding to the top of the head and KP2 corresponding to the neck. The detected keypoints also include KP21 corresponding to the left elbow, KP22 corresponding to the left wrist, KP23 corresponding to the right elbow, and KP24 corresponding to the right wrist. The detected keypoints further include KP6 corresponding to the left knee, KP7 corresponding to the left ankle, KP9 corresponding to the right knee, and KP10 corresponding to the right ankle. Among these keypoints, the keypoints KP1, KP2, and KP21 to KP24 belong to Person A. Although the keypoints KP6, KP7, KP9, and KP10 actually belong to Person B, they have been detected as keypoints for the knees and ankles of Person A, which are out of the frame. Accordingly, these keypoints are connected by dashed lines to form a keypoint group KPG2. As a result, the object detector 162 erroneously determines, based on the keypoint group KPG2, that Person A is in a pose suggesting that they have fallen or are lying down.

For example, suppose that the keypoint KP1 corresponding to the top of the head is located within a range of ±30 degrees relative to the keypoint KP2 corresponding to the neck, centered on a vertical axis in the image 600, and that the vertical dimension of the upper-body bounding box 602 is at least twice its horizontal dimension (i.e., the aspect ratio is 2 or greater). In this case, it is highly likely that Person A is actually in a standing or similar pose, and that the keypoints (KP6, KP7, KP9, and KP10) corresponding to the knees and ankles are not located above the keypoints KP21 and KP23 corresponding to the elbows. In the case of a lying-down pose, the ratio of the vertical dimension to the horizontal dimension of the upper-body bounding box 602 is smaller than in a standing or similar pose mentioned above. In addition, the positional relationship between the keypoint KP1 corresponding to the top of the head and the keypoint KP2 corresponding to the neck also differs between a lying-down pose and a standing or similar pose. When, as in this case, there is an inconsistency between the bounding box 602 and the positions of the detected keypoints (KP6, KP7, KP9, and KP10), the determination process in step S404 and the confidence reduction process in step S406 are performed. Through the confidence reduction process, it is possible to reduce the likelihood of an erroneous determination in step S404, where Person A is determined to be in a pose suggesting that they have fallen or are lying down. As a result, for example, Person A can be determined to be in a standing or similar pose. Note that in the examples illustrated in FIGS. 5 and 6, ten keypoints are detected for use in pose determination; however, the number of keypoints is not limited to ten, and pose determination can be performed using fewer or more than ten keypoints.

As described above, in this embodiment, the confidence reduction process can be incorporated based on information such as the positions and likelihoods of keypoints, as well as the positions, sizes, and likelihoods of bounding boxes. This helps prevent the processes in step S404 and step S405 from producing erroneous results. In this embodiment, the orientation of the head based on the positions of the person's eyes and ears is not taken into consideration; however, the embodiment is not limited thereto. For example, considering the orientation of the head may make it easier to determine whether a person is in an implausible pose. In addition, in certain events or sports, where typical poses are limited, it may also be appropriate to determine whether a pose is implausible based on the specific situation. Furthermore, when there is an inconsistency between the results of bounding box detection and keypoint detection, the confidence level of the bounding box may be reduced. The relative reliability between keypoints and bounding boxes may vary depending on factors such as the likelihoods of their respective detection results, the performance of the detector, and the scene.

### Second Embodiment

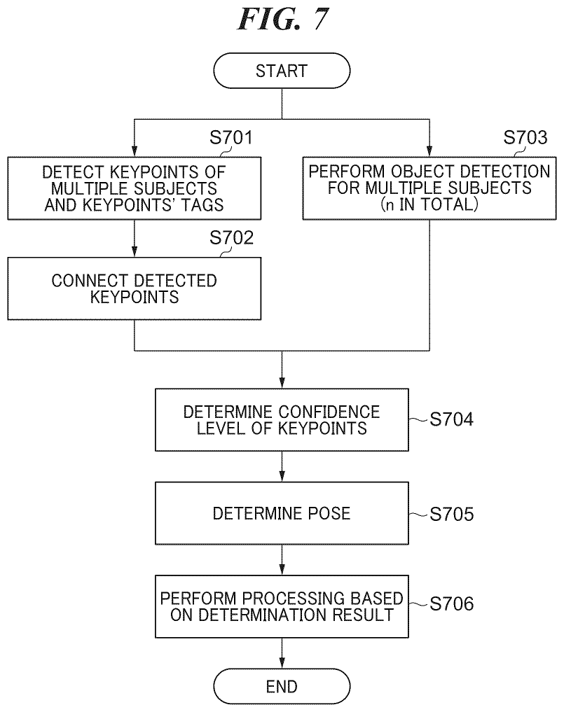

A second embodiment will be described below with reference to FIG. 7, focusing on differences from the previously described embodiment and without repeating the same explanation. FIG. 7 is a flowchart illustrating a pose estimation process performed by an imaging device according to the second embodiment. Here, it is assumed that the pose estimation process is applied to the image 500 illustrated in FIG. 5. As described above, suppose, for example, that the keypoint KP1 corresponding to the top of the head is located within a range of ±30 degrees relative to the keypoint KP2 corresponding to the neck, centered on a vertical axis in the image 500, and that the center of the head bounding box 502 is located within a distance equal to twice the size of the bounding box 502 from the lower edge of the image 500. In this case, it is highly likely that the upper body of Person A is partially out of the frame and that the keypoints corresponding to the hips, knees, and ankles are missing from the image. Therefore, in this embodiment, the confidence levels of the keypoints corresponding to the hips, knees, and ankles of Person A are reduced in step S704, and the pose is then determined accordingly in step S705, as illustrated in FIG. 7.

In the flowchart illustrated in FIG. 7, steps S701, S702, and S703 correspond to steps S401, S402, and S403, respectively, in the flowchart illustrated in FIG. 4. Upon completion of steps S702 and S703, the process proceeds to step S704. In step S704, the object detector 162 excludes the keypoints KP5 to KP10 corresponding to the hips, knees, and ankles, and the pose is then determined in step S705. This prevents the determination in step S705 and the processing in step S706 from producing erroneous results. Steps S705 and S706 correspond to steps S404 and S405, respectively, in the flowchart illustrated in FIG. 4. In this embodiment, the pose is determined with certain keypoints excluded; however, the embodiment is not limited thereto. For example, the pose may also be determined by taking into account a reduction in likelihood upon reducing the confidence levels of keypoints. This likewise helps prevent the determination in step S705 and the processing in step S706 from producing erroneous results. Similar effects can also be obtained for the image 600 illustrated in FIG. 6, as with the image 500 illustrated in FIG. 5.

### Third Embodiment

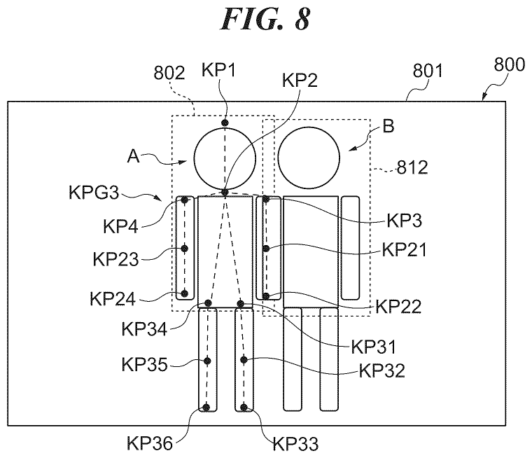

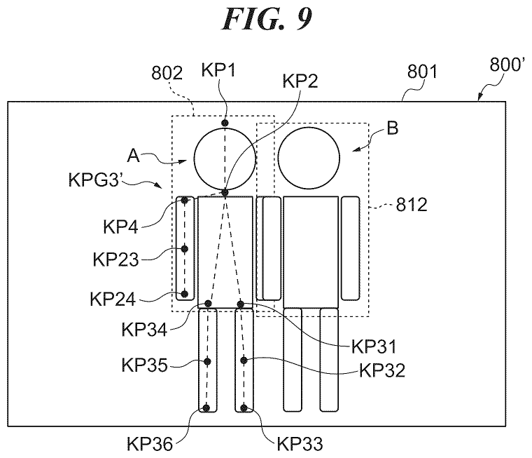

A third embodiment will be described below with reference to FIGS. 8 and 9, focusing on differences from the previously described embodiments and without repeating the same explanation. This embodiment is generally similar to the first embodiment, except for aspects related to the reliability of keypoints. FIGS. 8 and 9 are diagrams each illustrating an example of an input image, sent from an imaging controller to an object detector of an imaging device according to the third embodiment, on which keypoints and bounding boxes are superimposed. In an image 800 illustrated in FIG. 8, a solid line 801 represents the outer boundary of the image 800. The image 800 contains Person A and Person B. Person A is located on the left side of the image 800. Person B is located on the right side of the image 800. Person A is positioned behind Person B, and their bodies partially overlap. Specifically, in FIG. 8, the left arm of Person A overlaps the right arm of Person B. In this overlap region (overlapping portion), the confidence levels of keypoints and of pose determination are considered to be lower than in ordinary regions. Although the confidence level may also become lower due to a detection result, the present control adopts a rule-based approach to reduce the confidence level. Accordingly, it is preferable to reduce the confidence level of the determination based on keypoints, as in the first embodiment, or to reduce the confidence levels of the keypoints, as in the second embodiment. This helps prevent the pose determination or the processing based on the pose determination from producing erroneous results.

A bounding box 802 represents the detection result for the entire upper body of Person A and is indicated by a dotted line surrounding the entire upper body of Person A. Similarly, a bounding box 812 represents the detection result for the entire upper body of Person B and is indicated by a dotted line surrounding the entire upper body of Person B. FIG. 8 also illustrates an example of detected keypoints. The detected keypoints include KP1 corresponding to the top of the head, KP2 corresponding to the neck, KP3 corresponding to the left shoulder, and KP4 corresponding to the right shoulder. The detected keypoints also include KP21 corresponding to the left elbow, KP22 corresponding to the left wrist, KP23 corresponding to the right elbow, and KP24 corresponding to the right wrist. The detected keypoints further include KP31 corresponding to the left hip, KP32 corresponding to the left knee, and KP33 corresponding to the left ankle. The detected keypoints further include KP34 corresponding to the right hip, KP35 corresponding to the right knee, and KP36 corresponding to the right ankle. These keypoints are connected by dashed lines to form a keypoint group KPG3. In this embodiment, in step S404 of the flowchart illustrated in FIG. 4, the object detector 162 compares the bounding box 802, which encloses the upper body of Person A, with the bounding box 812, which is adjacent to the bounding box 802 and encloses the upper body of Person B. The object detector 162 then reduces the confidence level of the bounding box with fewer detected keypoints.

An image 800′ illustrated in FIG. 9 represents a case in which some keypoints of Person A may not be detected, even when the positional relationship between Person A and Person B is the same as in the image 800 illustrated in FIG. 8. In such a case, in step S404 of the flowchart illustrated in FIG. 4, the object detector 162 compares the bounding box 802, which encloses the upper body of Person A, with the bounding box 812, which is adjacent to the bounding box 802 and encloses the upper body of Person B that has been determined not to be Person A. If the amount of overlap is equal to or greater than a predetermined threshold, the confidence level of the pose determination result is reduced. Although this embodiment describes an example in which Person A is positioned behind Person B, Person A may instead be positioned in front of Person B, for example. In addition, the amount by which the confidence level is reduced may be varied (adjusted) depending on the distance or degree of overlap between the bounding boxes 802 and 812. Furthermore, as in the case of the image 800′ illustrated in FIG. 9, a condition in which the number of detected keypoints falls below a predetermined threshold may also serve as a criterion for reducing the confidence level of pose determination.

### Forth Embodiment

A fourth embodiment will be described below, focusing on differences from the previously described embodiments and without repeating the same explanation. This embodiment is similar to the third embodiment regarding aspects related to the reliability of keypoints and employs the same flowchart as the second embodiment. In this embodiment, as in the image 800 illustrated in FIG. 8 and the image 800′ illustrated in FIG. 9, the bounding box 802 that encloses the upper body of Person A is assumed to overlap the bounding box 812 that encloses the upper body of Person B. When the degree of overlap between the bounding boxes is equal to or greater than a predetermined threshold, among the keypoints included in the keypoint group, those located on the side of the bounding box 812 adjacent to the bounding box 802, specifically KP3, KP21, and KP22, have their confidence levels reduced. In this embodiment, in the flowchart illustrated in FIG. 7, the above-mentioned keypoints with low confidence levels are excluded in step S704, and the pose is determined accordingly in step S705. Additionally, in this embodiment, the amount by which the confidence levels are reduced or the keypoints whose confidence levels are to be reduced may be varied depending on the distance or degree of overlap between the bounding boxes 802 and 812.

### Fifth Embodiment

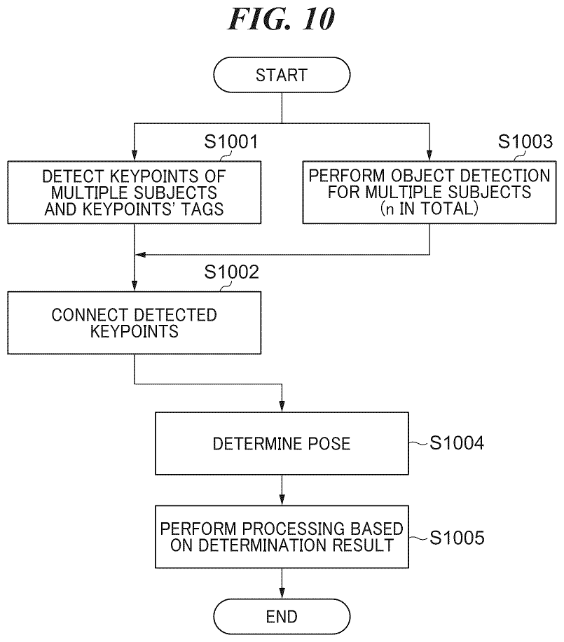

A fifth embodiment will be described below with reference to FIGS. 10 to 14, focusing on differences from the previously described embodiments and without repeating the same explanation. In this embodiment, connections between keypoints are determined based on the positional relationships between bounding boxes, such as those for the face, head, and upper body, identified as belonging to the same subject, and keypoints corresponding to the top of the head, joints, and the like. FIG. 10 is a flowchart illustrating a pose estimation process performed by an imaging device according to the fifth embodiment. In the flowchart illustrated in FIG. 10, steps S1001 and S1003 are performed in parallel. Steps S1001 and S1003 correspond to steps S401 and S403, respectively, in the flowchart illustrated in FIG. 4. Upon completion of steps S1001 and S1003, the process proceeds to step S1002. In step S1002, the object detector 162 connects keypoints using bounding boxes identified as belonging to the same subject. For example, the object detector 162 determines a keypoint connection range, i.e., keypoints to be connected, based on the positions and shapes of the bounding boxes for the head and upper body. The connection range may be determined through various methods. For example, one method involves determining whether to connect keypoints based on information about the distance between them. Another method involves generating a cost function based on the likelihoods of the keypoints, tag IDs, and likelihood-related information, and connecting a combination of keypoints that minimizes the cost function.

In this embodiment, a positional range for keypoints corresponding to the top of the head, neck, shoulders, hips, or knees, as well as keypoints to be connected, is determined based on the positions and shapes of the bounding box enclosing the head and the bounding box enclosing the upper body. A cost function is applied such that a cost of 0 is assigned to keypoints within the determined range, while a cost of ∞ (infinity) is assigned to those outside the range, thereby preventing the connection of keypoints located outside the range. This improves the accuracy of connections between keypoints. It is also possible to vary the cost for keypoints within the range, depending on their positions. Although the keypoints corresponding to the top of the head and the neck are expected to be located within the bounding box enclosing the head, in this embodiment, the predetermined range may be defined to be, for example, 1.3 times the size of the bounding box, centered on its center, to account for potential detection errors. If the keypoints corresponding to the top of the head and the neck fall outside this range, they are not connected. In addition, in this embodiment, the positions of the top of the head and the neck can be estimated based on the positions and shapes of the bounding box enclosing the head and the bounding box enclosing the upper body. Accordingly, the range may be further restricted, or the cost function may be varied. In this embodiment, a range for keypoints corresponding to the shoulders, hips, or knees can also be defined in a similar manner based on the positions and shapes of the bounding box enclosing the head and the bounding box enclosing the upper body. Furthermore, the orientation of the body or the like can be estimated based on the number and positions of detected pupils, and the result of this estimation can be used for keypoint connection.

Upon completion of step S1002, the process proceeds sequentially to step S1004 and step S1005. Steps S1004 and S1005 correspond to steps S404 and S405, respectively, in the flowchart illustrated in FIG. 4.

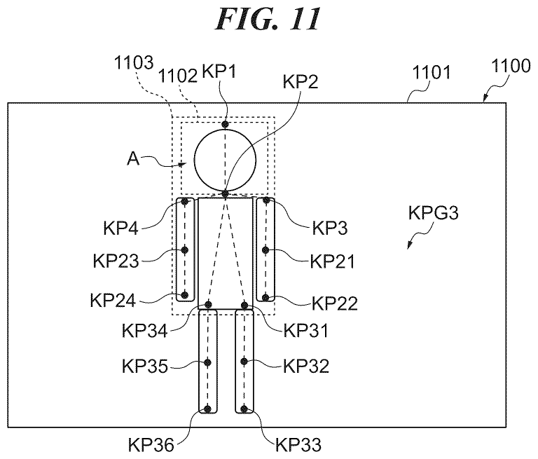

FIGS. 11 to 14 are diagrams each illustrating an example of an input image, sent from an imaging controller to an object detector of the imaging device according to the fifth embodiment, on which keypoints and bounding boxes are superimposed. In an image 1100 illustrated in FIG. 11, a solid line 1101 represents the outer boundary of the image 1100. The image 1100 contains Person A. Person A is located in the central area of the image 1100 in a standing pose, with the entire body captured. The image 1100 also contains bounding boxes 1102 and 1103. The bounding box 1102, indicated by a dotted line, encloses the head of Person A. The bounding box 1103, also indicated by a dotted line, encloses the upper body of Person A. As illustrated in FIG. 11, when Person A assumes an upright pose, the bounding box 1103 appears as a vertically elongated rectangle in the image 1100. All detected keypoints belong to Person A and are connected by dashed lines to form the keypoint group KPG3. In such a case, the shoulders (keypoints KP3 and KP4) are located between the vicinity of the bounding box 1102 and around the center of the bounding box 1103 in the longitudinal direction. The hips (keypoints KP31 and KP34) are located near the lower end of the bounding box 1103. The knees (keypoints KP32 and KP35) are located near or outside the lower end of the bounding box 1103.

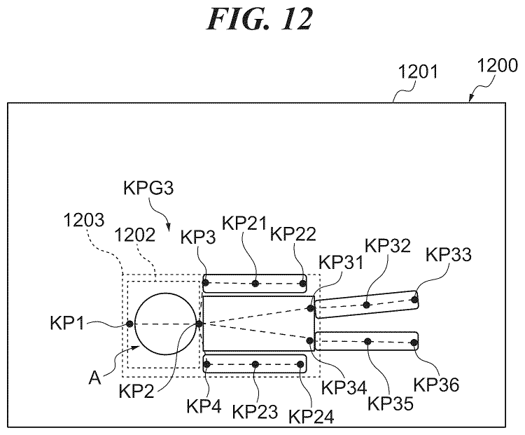

In an image 1200 illustrated in FIG. 12, a solid line 1201 represents the outer boundary of the image 1200. The image 1200 contains Person A. Person A is located in the lower area of the image 1200, in a fallen or lying-down position, with the entire body captured. The image 1200 also contains bounding boxes 1202 and 1203. The bounding box 1202, indicated by a dotted line, encloses the head of Person A. The bounding box 1203, also indicated by a dotted line, encloses the upper body of Person A. As illustrated in FIG. 12, when Person A assumes an upright pose, the bounding box 1203 appears as a horizontally elongated rectangle in the image 1200. In such a case as well, as in FIG. 11, the shoulders are located between the vicinity of the bounding box 1202 and around the center of the bounding box 1203 in the longitudinal direction. The hips are located near the right end of the bounding box 1203. The knees are located near or outside the right end of the bounding box 1203. In this embodiment, erroneous keypoint connections can be reduced by defining a positional range for keypoints expected from the position of each bounding box, as well as a connection range for connecting the keypoints. Note that the number of bounding boxes is not limited to two; it may be three or more, for example.

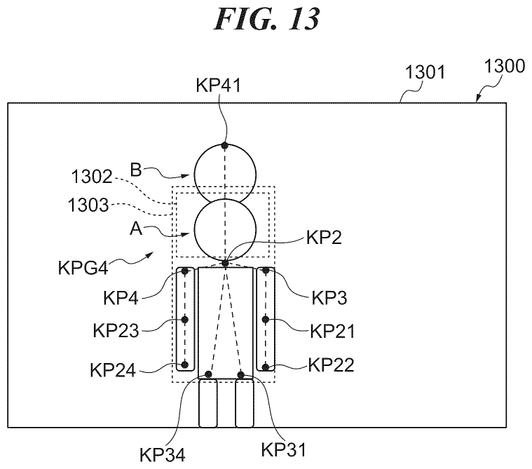

In an image 1300 illustrated in FIG. 13, a solid line 1301 represents the outer boundary of the image 1300. The image 1300 contains Person A and Person B. Person A is located in the central area of the image 1300 in a standing pose, with the entire upper body captured. Person B is positioned behind Person A, with only the head captured. The image 1300 also contains bounding boxes 1302 and 1303. The bounding box 1302, indicated by a dotted line, encloses the head of Person A. The bounding box 1303, also indicated by a dotted line, encloses the upper body of Person A. FIG. 13 also illustrates an example of detected keypoints. The detected keypoints include KP41 corresponding to the top of the head, KP2 corresponding to the neck, KP3 corresponding to the left shoulder, and KP4 corresponding to the right shoulder. The detected keypoints also include KP21 corresponding to the left elbow, KP22 corresponding to the left wrist, KP23 corresponding to the right elbow, and KP24 corresponding to the right wrist. The detected keypoints further include KP31 corresponding to the left hip and KP34 corresponding to the right hip. Among these keypoints, the keypoint KP41 belongs to Person B, while the remaining keypoints belong to Person A. Although the keypoint KP41 actually belongs to Person B, it has been detected as a keypoint of Person A. As a result, these keypoints are connected by dashed lines to form a keypoint group KPG4. By restricting the positional range for the keypoints to the vicinity of the bounding box, it is possible to reduce erroneous connections, such as where the keypoint KP41, actually belonging to Person B, is mistakenly connected to the keypoints of Person A, as illustrated in FIG. 13.

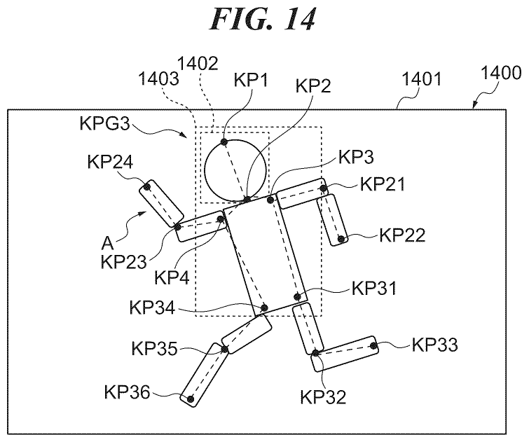

In an image 1400 illustrated in FIG. 14, a solid line 1401 represents the outer boundary of the image 1400. The image 1400 contains Person A. Person A is located in the central area of the image 1400 in a running pose, with the entire body captured and the upper body leaning forward. The image 1400 also contains bounding boxes 1402 and 1403. The bounding box 1402, indicated by a dotted line, encloses the head of Person A. The bounding box 1403, also indicated by a dotted line, encloses the upper body of Person A. When Person A is in a pose where the upper body leans forward, the difference (or ratio) between the vertical and horizontal dimensions of the bounding box 1403 becomes smaller compared to when Person A is in an upright pose. In such a state, in the bounding box 1403, the hips (keypoints KP31 and KP34) are located diagonally opposite to the location of the bounding box 1402. Therefore, by defining a positional range for the hip keypoints or by varying the cost function according to the positions of the keypoints, it is possible to reduce erroneous connections between keypoints.

Although the imaging device 100 has been described as a device that incorporates an image processing apparatus and performs the pose estimation process internally, it is not limited thereto. For example, the imaging device 100 may be communicably connected to an information processing apparatus (e.g., a server), which in turn may incorporate the image processing apparatus. In this case, the information processing apparatus performs the pose estimation process. The type of information processing apparatus is not particularly limited and may include, for example, a desktop or notebook personal computer, a tablet device, and a smartphone.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-113309, filed Jul. 16, 2024, which is hereby incorporated by reference herein in its entirety.

What is claimed is:

1. An image processing apparatus, comprising:
one or more processors; and
at least one memory coupled to the one or more processors and having stored thereon instructions which, when executed by the one or more processors, cause the one or more processors to:
detect a plurality of keypoints for a subject in an image;
determine whether the keypoints belong to the same subject;
extract a bounding box that encloses a body part of a subject in the image and indicates a detection range of the subject;
determine whether the bounding box corresponds to the same subject as the keypoints; and
reduce, according to at least a positional relationship between the keypoints determined to belong to the same subject and the bounding box determined to correspond to the same subject as the keypoints, a confidence level of at least one of the bounding box and the keypoints, or a confidence level of pose estimation for the subject using the keypoints.

2. The image processing apparatus according to claim 1, wherein the instructions further cause the one or more processors to reduce, according to at least a positional relationship between the keypoints determined to belong to the same subject and a bounding box that is adjacent to the bounding box determined to correspond to the same subject as the keypoints and is determined not to correspond to the same subject as the keypoints, the confidence level of at least one of the bounding box and the keypoints, or the confidence level of pose estimation for the subject using the keypoints.

3. The image processing apparatus according to claim 1, wherein the instructions further cause the one or more processors to determine whether the detected keypoints belong to the same subject using tag information and a likelihood of the tag information, the tag information indicating positions and likelihoods of the keypoints and a classification of the subject.

4. The image processing apparatus according to claim 1, wherein the instructions further cause the one or more processors to determine whether the bounding box corresponds to the same subject as the keypoints based on a degree of overlap or a distance between the subject for which the keypoints have been detected and the subject for which the bounding box has been extracted, or a degree of overlap or a distance between a region formed by the keypoints determined to belong to the same subject and the bounding box.

5. The image processing apparatus according to claim 1, wherein
the subject is a human, and
the instructions further cause the one or more processors to reduce, when an upper body of the human is included in the bounding box, the confidence level of at least one of the bounding box and the keypoints, or the confidence level of pose estimation, according to an aspect ratio of the bounding box determined to correspond to the same subject as the keypoints and a positional relationship of the keypoints.

6. The image processing apparatus according to claim 1, wherein
the subject is a human, and
the instructions further cause the one or more processors to reduce, when a head of the human is included in the bounding box, the confidence level of at least one of the bounding box and the keypoints, or the confidence level of pose estimation, according to a positional relationship between the bounding box and keypoints corresponding to the head.

7. The image processing apparatus according to claim 1, wherein, when a plurality of bounding boxes are extracted and an overlapping portion is formed where the bounding box determined to correspond to the same subject as the keypoints partially overlaps a bounding box determined not to correspond to the same subject as the keypoints, the processing circuitry reduces a confidence level of a keypoint located in the overlapping portion.

8. The image processing apparatus according to claim 1, wherein the instructions further cause the one or more processors to connect the detected keypoints with a straight line.

9. An image processing apparatus, comprising:
one or more processors; and
at least one memory coupled to the one or more processors and having stored thereon instructions which, when executed by the one or more processors, cause the one or more processors to:
detect a plurality of keypoints for a subject in an image;
connect the keypoints with a straight line;
extract a bounding box that encloses a body part of a subject in the image, the subject being a target for pose or action estimation, and that indicates a detection range of the subject;
determine whether the bounding box corresponds to the same subject as the keypoints; and
determine, when the bounding box is determined to correspond to the same subject as the keypoints, keypoints to be connected, among the detected keypoints, according to at least a positional relationship between the detected keypoints and the extracted bounding box.

10. The image processing apparatus according to claim 9, wherein the instructions further cause the one or more processors to determine the keypoints to be connected according to a size of the bounding box.

11. The image processing apparatus according to claim 9, wherein the instructions further cause the one or more processors to determine whether the bounding box corresponds to the same subject as the keypoints based on a degree of overlap or a distance between the subject for which the keypoints have been detected and the subject for which the bounding box has been extracted.

12. The image processing apparatus according to claim 1, wherein the instructions further cause the one or more processors to detect at least one of the following parts of the subject as a keypoint: a pupil, an ear, a crown, a neck, a shoulder, an elbow, a wrist, a hip, a knee, and an ankle.

13. The image processing apparatus according to claim 9, wherein the instructions further cause the one or more processors to detect at least one of the following parts of the subject as a keypoint: a pupil, an ear, a crown, a neck, a shoulder, an elbow, a wrist, a hip, a knee, and an ankle.

14. The image processing apparatus according to claim 1, comprising an imager that includes an image sensor configured to capture the image of the subject.

15. The image processing apparatus according to claim 9, comprising an imager that includes an image sensor configured to capture the image of the subject.

16. A method for controlling an image processing apparatus, comprising:
detecting a plurality of keypoints for a subject in an image;
determining whether the keypoints belong to the same subject;
extracting a bounding box that encloses a body part of a subject in the image and indicates a detection range of the subject;
determining whether the bounding box corresponds to the same subject as the keypoints; and
reducing, according to at least a positional relationship between the keypoints determined to belong to the same subject and the bounding box determined to correspond to the same subject as the keypoints, a confidence level of at least one of the bounding box and the keypoints, or a confidence level of pose estimation for the subject using the keypoints.

17. A method for controlling an image processing apparatus, comprising:
detecting a plurality of keypoints for a subject in an image;
connecting the keypoints with a straight line;
extracting a bounding box that encloses a body part of a subject in the image, the subject being a target for pose or action estimation, and that indicates a detection range of the subject;
determining whether the bounding box corresponds to the same subject as the keypoints; and
determining, when the bounding box is determined to correspond to the same subject as the keypoints, keypoints to be connected, among the detected keypoints, according to at least a positional relationship between the detected keypoints and the extracted bounding box.

18. A computer program product, comprising a non-transitory computer-readable medium having stored thereon computer-executable instructions which, when executed by a computer, cause the computer to function as the image processing apparatus according to claim 1.

19. A computer program product, comprising a non-transitory computer-readable medium having stored thereon computer-executable instructions which, when executed by a computer, cause the computer to function as the image processing apparatus according to claim 9.
